(19) United States
(12) Patent Application Publication
(10) Pub. No.: US 2010/0098370 A1
(43) Pub. Date: Apr. 22, 2010

(54) ROLLER BEARING

(76) Inventors: Peter De Kock, Oberhausen (DE); Ronald Jabs, Moers (DE); Hermann Erwig, Dinslaken (DE)

Correspondence Address: FRIEDRICH KUEFFNER, 317 MADISON AVENUE, SUITE 910, NEW YORK, NY, 10017, US

(21) Appl. No.: 12/449,598

(22) PCT Filed: Jan. 22, 2008
(86) PCT No.: PCT/EP2008/000449

§ 371 Date: Dec. 11, 2009

(30) Foreign Application Priority Data
Feb. 16, 2007 (DE) 10 2007 008 307.8
Aug. 28, 2007 (DE) 10 2007 040 584.9
Nov. 21, 2007 (DE) 10 2007 055 625.1

(51) Int. Cl. F16C 19/30

(52) U.S. Cl. 384/618

(57) ABSTRACT

Roller bearing (100) for mounting a roller journal (210) of a roller (200) in a roller arm (300) of a hot dip coating installation, wherein the roller (200) can be dipped into a metal bath (400) with the aid of the roller arm and is used therein for guiding a strip (500) running through the metal bath. In order to improve known roller bearings for hot dip coating installations to the extent that the bearing arrangement is not adversely affected by a skewed positioning of the roller arm, it is proposed according to the invention to configure the roller bearing cardanically.

The invention relates to a roller bearing for the bearing arrangement of a roller journal in a roller arm of a hot dip coating installation.

In strip processing lines with hot dip coating for metallic coatings, deflecting rollers, correcting rollers and stabilizing rollers are used in the coating baths, referred to below as metal baths, in order to guide the strip through the bath. According to the prior art, these components are mounted in ceramic sliding bearings. Examples thereof are disclosed in the documents DE 195 11 943 A1, DE 102 27 778 A1 and DE 102 36 113 B3.

Known roller bearings are arranged in what are known as roller arms of the hot dip coating installation, with which roller arms a respective roller is dipped in the metal bath. The roller is mounted in the roller bearings by means of its roller journals. The roller bearings installed in the roller arms are generally rigid or mounted in such a manner that they can only move in one direction in the prior art. In the event of a skewed positioning between the roller journal and the bearing surface, as can occur for example as a result of alignment errors or thermal deformation, the roller journal no longer lies completely on the roller bearing. The results of this are higher surface pressures and therefore greater wear of the roller bearings.

The German utility model application DE 1 876 305 relates to a pivoting bearing for transmitting high radial and axial forces, in which an inner ring which is provided with a cylindrical running face and a convexly curved outer face is mounted in a sliding manner in a second ring which is provided with a correspondingly concave inner face. The rings are connected to each other such that they can pivot about a radial axis by means of journals.

The document DE 101 30 959 discloses a coating device with a shaft which is mounted rotatably in a sliding bearing, for guiding a metal strip. The sliding bearing is formed by a bearing housing and an open bearing shell with two bearing surfaces which is contained therein. The two bearing shell halves/bearing surfaces consist of ceramic material. The two bearing surfaces are arranged at approximately equal angles on both sides of the resulting force R.

DE 195 11 943 A1 discloses a roller bearing for the bearing arrangement of a roller journal in a roller arm of a hot dip coating installation. The roller can be dipped by means of the roller arm into a metal bath and is used therein to guide a strip which passes through the metal bath. The roller bearing is configured cardanically, conditional on, that is, with respect to two degrees of freedom. A bushing with an opening for receiving the roller journal is mounted in the roller arm. Moreover, an insert and at least one bearing body are provided for the roller journal.

Starting from this prior art, the invention is based on the object of further improving a roller bearing for rollers in a hot dip coating installation to the extent that the bearing arrangement of the roller journal or of the roller is not adversely affected even in instances of skewed positioning between the roller journal and the bearing surface and that the bearing body with the bearing surfaces can always be aligned symmetrically with respect to a resulting, loading force.

This object is achieved by the subject matter of Patent Claim 1. The latter is characterized in that the bearing body is mounted in the insert such that it can pivot about a second pivot axis and that the bushing, together with the insert mounted therein and the bearing body, is mounted in the roller arm so as to be pivotable about an axis, which runs perpendicularly on the axes S1 and S2, and can be set fixedly at a defined twisting angle.

The cardanic configuration of the roller journal has the advantage that the rollers or the roller journal is mounted in the roller bearing so as to be rotatable not only about the roller axis, but also so as to be movable in at least one further degree of freedom, without the quality of the bearing arrangement being adversely affected for example as a result of increased friction.

The possibility of rotating the roller about its own roller axis is referred to below as the first degree of freedom. The further claimed possibility of pivoting the bearing body in the insert about the second pivot axis S2 represents a further degree of freedom for the roller, referred to as the third degree of freedom below.

The possibility of twisting the bushing together with the insert mounted therein and the bearing body in the roller arm by a defined twisting angle α about the central axis of the cylindrical bushing has the advantage that the bearing body with the bearing surfaces can be aligned symmetrically with respect to a resulting force, which arises as a result of the tensile forces exerted on the roller by the deflected metal strip and acts on the roller bearing. The resulting force does not always act perpendicularly upwards to the bath surface, but rather its direction depends primarily on the entering and exiting angles of the metal strip around the roller.

According to a first exemplary embodiment of the roller bearing, said roller bearing is characterized by a bushing mounted in the roller arm, which bushing has an opening for accommodating the roller journal and an insert, with the insert being mounted in the bushing so as to be pivotable about a first pivot axis S1. The possibility of pivoting about the pivot axis S1 represents a further, second degree of freedom for the roller. In total three degrees of freedom are thus available to the roller in this case.

The configuration of two bearing surfaces arranged on the bearing body in a V-shaped manner has the advantage that the roller journal is stabilized in its local or spatial position when it is mounted on the bearing body, even when a rotary movement is being carried out.

A configuration of the bearing body, at least however the bearing surfaces, in ceramic has the advantage of low wear with at the same time high resistance to temperature.

The bearing bodies, at least however the bearing surfaces, are advantageously exchangeable as parts subject to wear.

It is sufficient if the insert and/or the bearing body are not arranged completely around the edge of the opening in the bushing, but only on the load-bearing side of the roller bearing, because a force is only exerted on the bearing surfaces there during operation of the hot dip coating installation, that is, while the metal strip is being deflected in the metal bath by the roller.

The roller journal is mounted in the opening of the roller bushing loosely, that is, so as to be freely rotatable. When loaded, that is when the resulting tensile force arises due to the deflected metal strip, the roller journal is pressed from below against the said bearing surfaces; when this resulting tensile force is absent, that is when the hot dip coating installation is not operating, the roller journal along with the roller drops down to the lowest point of the opening in the bushing and then generally no longer has contact with the bearing surfaces. Because the opening in the bushing is greater than the diameter of the roller journal, the movable roller axis does not generally coincide with the centre axis of the cylindrical bushing.

The roller bearing described according to the present invention is suitable not just for deflecting rollers, but also for correcting rollers or stabilizing rollers for guiding the metal strip inside or outside the metal bath.

Further advantageous configurations of the invention are the subject matter of the dependent claims.

Attached to the description are in total four figures, in which

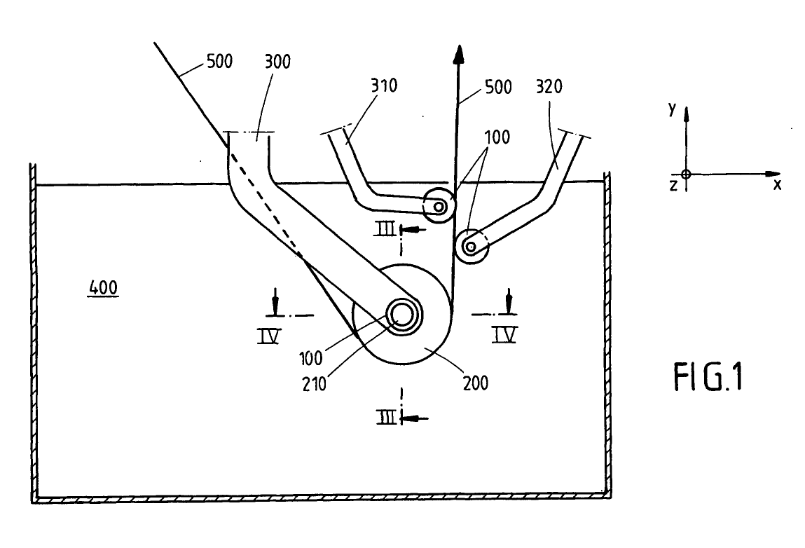

FIG. 1 shows a roller arm with rollers dipped in the metal bath of a hot dip coating installation;

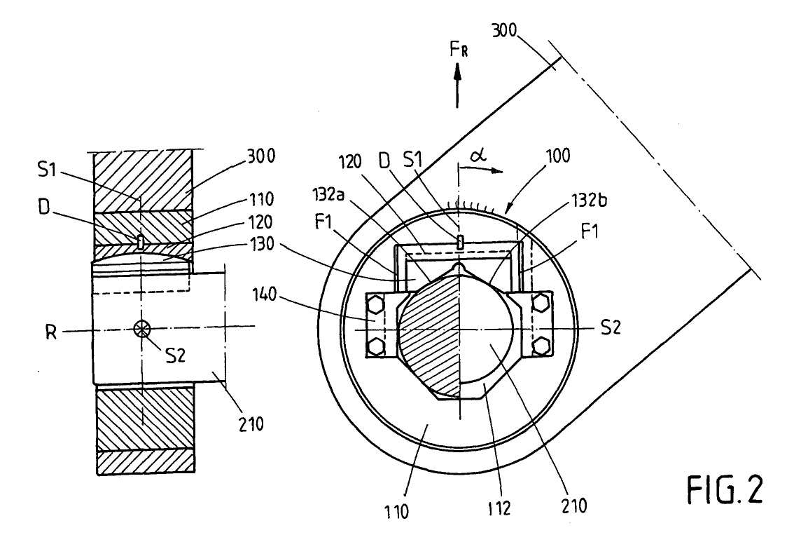

FIG. 2 shows the construction of the roller bearing according to the invention in detail;

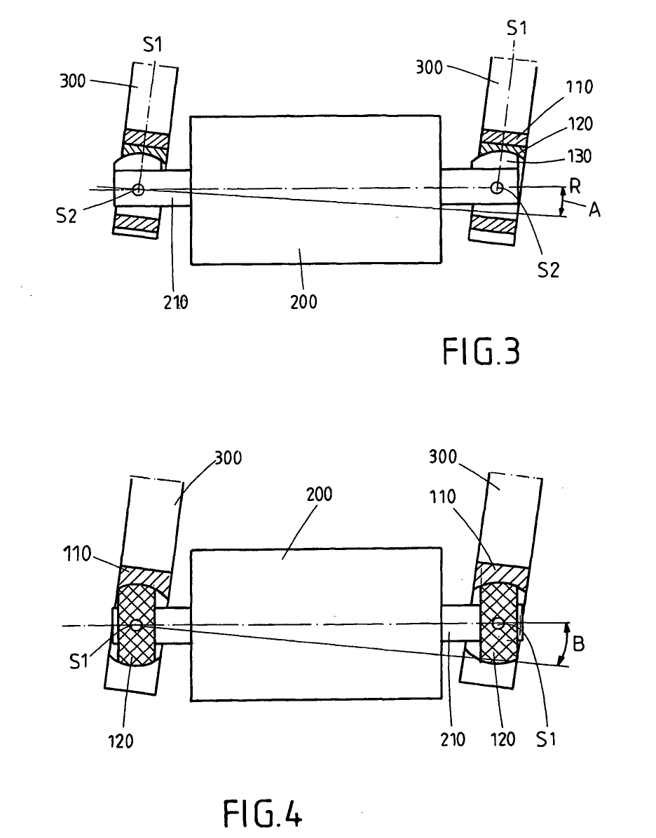

FIG. 3 shows a first cross-sectional view of the roller mounted in the roller arms; and

FIG. 4 shows a second cross-sectional view of the roller mounted in the roller arms.

The invention is described in detail below using the figures in the form of exemplary embodiments.

FIG. 1 shows the essential parts of a hot dip coating installation, namely a metal bath 400 containing liquid metal for coating a strip 500, in particular a metal strip. A roller 200, mounted on a roller arm 300, is dipped into the metal bath 400. The roller is mounted on the roller arm 300 by means of a roller bearing 100 according to the invention. The roller 200 in FIG. 1 is used for deflecting a metal strip 500 in the metal bath. In addition to the large roller arm 300, smaller roller arms 310, 320 are shown in FIG. 1, on which smaller roller arms correcting rollers or stabilizing rollers for guiding the metal strip 500 are mounted with the aid of the roller bearing 100 according to the invention.

FIG. 2 illustrates the construction of the roller bearing 100 according to the invention. The roller bearing 100 is configured cardanically and offers a possibility of movement in a plurality of degrees of freedom for the roller 200 or for the roller journal 210.

In FIG. 2, the lower end of the roller arm 300 is shown, in which a bushing 110 with an opening 112 for accommodating the roller journal 210 is mounted. The roller journal 210 is mounted in the opening 112 so as to be freely rotatable about the roller axis R. Any existing play between the outside of the roller journal and the inside of the opening is harmless.

The possibility of rotating about the roller axis represents a first degree of freedom for the movements of the roller 200.

According to a first exemplary embodiment, an insert 120 is mounted in the bushing so as to be rotatable about a first pivot axis S1. The rotation takes place for example about a pivot pin D. In this case, the surfaces F arranged opposite and rotationally symmetrically with respect to the first pivot axis are configured in a rounded or cylindrical manner, so that the pivoting movement of the insert within the bushing is possible at all. The possibility of pivoting about the first pivot axis S1 represents a second degree of freedom for the roller 200.

According to a further exemplary embodiment, a bearing body 130 for the roller journal is mounted in the insert 120 so as to be pivotable about a second pivot axis S2. In order to allow this pivoting movement, the opposite surfaces of insert 120 and bearing body 130 are configured in a rounded, that is, cylindrical manner with respect to the pivot axis S2. The possibility of pivoting about the pivot axis S2 represents a third degree of freedom for the roller.

The exemplary embodiments just described for realizing the second and third degrees of freedom can each be realized individually but also combined with each other in the roller bearing, as illustrated in FIG. 2. The bearing body 130 has two bearing surfaces 132a, 132b arranged in a V-shaped manner, on which bearing surfaces the roller journal 210 is mounted in a rotatable manner, in particular when loaded by the deflected metal strip 500. In the exemplary embodiment shown in FIG. 2, the roller journal 210 is pressed from below against the bearing surfaces 132a, 132b arranged in a V-shaped manner. This pressing against the roller journal or the roller arises due to a resulting force F_{R}, which is exerted on the roller and the roller journal by the metal strip deflected by the roller and acts for example perpendicularly upwards in the direction of the arrow in FIG. 2. In this operating state, play can exist towards the bottom of the opening 112, as is indicated in FIG. 2. The bearing body 130 can be configured either integrally or preferably in two pieces, with each part of the bearing body having the bearing surfaces 132a and 132b. The bearing bodies, at least however the bearing surfaces, are preferably arranged in the roller bearing so as to be exchangeable as parts subject to wear. The bearing bodies 130, at least however the bearing surfaces 132a, 132b are preferably manufactured from ceramic, because ceramic is on the one hand particularly hard and therefore particularly resistant to wear and on the other hand can withstand the high ambient temperatures prevailing inside the metal bath. The insert and the bearing body are fixed with the aid of fixing means 140 on the load-bearing side of the opening 112 in the bushing 110. The load-bearing side is that side against which the roller journal is pressed due to the resulting tensile force F_{R} when the metal strip is deflected.

In FIG. 2 it can be seen that the bushing 110 is rotatably mounted in the roller arm. In concrete terms, the bushing can be aligned to a predeterminable twisting angle α. The bushing is aligned in the direction of the resulting tensile force F_{R}, with the direction of this resulting tensile force being dependent on the angles at which the metal strip dips into the metal bath before it is deflected by the roller 200 and on the exiting angle at which the metal strip leaves the metal bath after it has been deflected by the roller 200. The roller bearing according to the invention is then aligned when the direction of the first pivot axis S1 corresponds with the direction of the tensile force F_{R}. The alignment has the advantage that the two V-shaped bearing surfaces 132a, 132b are loaded to the same extent during operation of the hot dip coating installation, when subjected to loading by the roller journal as the metal strip 500 is deflected.

FIG. 3 shows a cross section through the roller arm 300 with roller 200 mounted therebetween, in the plane III-III according to FIG. 1.

FIG. 3 shows a skewed positioning of the roller arm 300 in the viewing direction III. FIG. 3 shows how in this case the roller bearing 100 compensates this skewed positioning of the roller arm 300 without thereby adversely affecting the bearing arrangement of the roller 200 or of the roller journal 210. In concrete terms, the third degree of freedom in particular becomes effective in this case, in which the bearing body 130 is pivoted out by the angle A about the second pivot axis S2 with respect to the insert.

In contrast to FIG. 3, FIG. 4 shows a plan view of the arrangement shown in FIG. 1, in the plane IV-IV. In the event of a skewed positioning of the roller arm 300 from this perspective, that is in the X-Z plane, the second degree of freedom becomes effective, in which the insert 120 is displaced with respect to the bushing 110 rotatably about the first pivot axis S1. A compensation of the said skewed positioning of the roller arm 300 is also brought about in this case by the cardanic roller bearing. When the first, second and third degrees of freedom are realized in the roller bearing by the embodiment shown in FIG. 2, an improved bearing arrangement of the roller with lower friction is possible independently of the skewed position of the roller arm.

1. Roller bearing (100) for mounting a roller journal (210) of a roller (200) in a roller arm (300) of a hot dip coating installation, wherein the roller (200) can be dipped into a metal bath (400) with the aid of the roller arm (300) and is used therein for guiding a strip (500) running through the metal bath;
wherein the roller bearing (100) is configured cardanically for the cardanic bearing arrangement of the roller journal (210); and
wherein a bushing (110) mounted in the roller arm (300) with an opening (112) for receiving the roller journal (210), an insert (120) and at least one bearing body (130) for the roller journal (210) is provided;
wherein
the bearing body (130) is mounted in the insert (120) such that it can pivot about a second pivot axis (S2); and
the bushing (110) together with the insert (120) mounted therein and the bearing body (130) are mounted in the roller arm (300) so as to be pivotable about an axis (R), which axis is perpendicular to the axes S1 and S2, and the bushing can be set fixedly to a defined twisting angle (α).

2. Roller bearing (100) according to claim 1, comprising
a bushing (110) mounted in the roller arm (300), which bushing has an opening (112) for accommodating the roller journal (210) and an insert (120), wherein the insert is mounted in the bushing so as to be pivotable about a first pivot axis (S1).

3. Roller bearing (100) according to claim 1, wherein
the insert (120) is mounted in the bushing (110) so as to be pivotable about a first pivot axis (S1), which is perpendicular to the pivot axis (S2).

4. Roller bearing (100) according to claim 1, wherein
the bearing body (130) has two bearing surfaces (132a, 132b) arranged in a V-shaped manner, on which bearing surfaces the roller journal (210) of the roller (200) is mounted in a rotatable manner, in particular when loaded by the deflected metal strip (500).

5. Roller bearing (100) according to claim 4, wherein
the bearing body (130a, 130b) is configured in two pieces and wherein the two bearing surfaces (132a, 132b) are each assigned to one part of the bearing body.

6. Roller bearing (100) according to claim 4, wherein
the bearing bodies (130), at least however the bearing surfaces, are fabricated from ceramic.

7. Roller bearing (100) according to claim 5, wherein
the at least one bearing body (130) can be exchanged as a part subject to wear.

8. Roller bearing (100) according to claim 3, wherein
the insert (120) and/or the bearing body (130) are only configured on the load-bearing side of the roller bearing in order to accommodate the pressing forces of the roller journal (210) when the metal strip is deflected; and
the insert (120) and the bearing body (130) are fixed to the load-bearing side of the roller bearing with fixing means (140).

9. Roller bearing (100) according to claim 1, wherein
the twisting angle (α) is selected in such a manner that the two V-shaped bearing surfaces (132a, 132b) are loaded to the same extent during operation of the hot dip coating installation when loaded by the roller journal (210) as the metal strip (500) is deflected.
